(19) United States
(12) Patent Application Publication
(10) Pub. No.: US 2026/0161176 A1
(43) Pub. Date: Jun. 11, 2026

(54) SYSTEM AND METHOD FOR MODIFYING ENVIRONMENTAL IMPACT IN MATERIAL HANDLING ENVIRONMENTS

(71) Applicant: Toyota Material Handling, Inc., Columbus, IN (US)

(72) Inventor: Joshua GC Linnemann, Columbus, IN (US)

(21) Appl. No.: 19/414,715

(22) Filed: Dec. 10, 2025

Related U.S. Application Data
(60) Provisional application No. 63/730,065, filed on Dec. 10, 2024.

(51) Int. Cl. G05D 1/644; B66F 9/06; G05D 1/698; G05D 105/28; G05D 107/70

(52) U.S. Cl. CPC G05D 1/644; B66F 9/063; G05D 1/6987; G05D 2105/28; G05D 2107/70

(57) ABSTRACT

A computing system for a material handling environment is provided. The computing system includes a memory storing instructions and a processor in communication with the memory and a telemetry system associated with one or more material handling vehicles. The processor is configured to execute the instructions to cause the processor to receive a selection of a performance mode for the one or more material handling vehicles from a user interface, output a command to the one or more material handling vehicles to operate in accordance with the selected performance mode, generate a first visualization of an environmental impact of the one or more material handling vehicles based at least in part on the selected performance mode and energy consumption data corresponding to the one or more material handling vehicles, and display the visualization of the environmental impact on the user interface.

### CROSS-REFERENCE TO RELATED APPLICATIONS

This application claims the benefit of U.S. Provisional Application No. 63/730,065, filed Dec. 10, 2024, the entirety of which is herein incorporated by reference.

### FIELD

This disclosure generally relates to material handling vehicles. More specifically, this disclosure relates to modifying an environmental impact of material handling vehicle systems.

### BACKGROUND

Conventional material handling vehicles, such as forklifts, may incorporate multiple vehicle modes to customize an operator's experience (e.g., lifting, tilting, and top speed). However, to achieve this, each individual vehicle may utilize local configuration by a fleet manager to customize performance modes. This process can be costly and time consuming for material handling fleet managers. Accordingly, a need exists in the art for vehicle modes to be set externally from the material handling vehicle. Further, a need exists for charging schemes to be set remotely from material handling vehicle chargers. Additionally, a need exists in the art to simulate the environmental impact of a vehicle and charger system.

### SUMMARY

Examples disclosed herein relate to a computing system for a material handling environment. The computing system includes a memory storing instructions and a processor in communication with the memory and a telemetry system of one or more material handling vehicles. The processor is configured to execute the instructions to cause the processor to receive a selection of a performance mode for the one or more material handling vehicles from a user interface, output a command to the one or more material handling vehicles to operate in accordance with the selected performance mode, generate a first visualization of an environmental impact of the one or more material handling vehicles based at least in part on the selected performance mode and energy consumption data corresponding to the one or more material handling vehicles, and display the visualization of the environmental impact on the user interface.

In some aspects, the performance mode is associated with a set of operating parameters including acceleration parameters, lift speed parameters, steering parameters, braking force parameters, regenerative braking parameters, mast lowering parameters, or a combination thereof.

In some aspects, the instructions further cause the processor to receive an environmental impact reduction plan and select operating parameters associated with the performance mode according to the environmental impact reduction plan.

In other aspects, the environmental impact reduction plan indicates a target energy consumption reduction per period of time for the one or more material handling vehicles.

In further aspects, the instructions further cause the processor to modify the performance mode selection based on the energy consumption data and output a command to the one or more material handling vehicles to implement the modification.

In some aspects, the instructions further cause the processor to dynamically select the performance mode based on a time of day, a task performed by the one or more material handling vehicles, a remaining battery charge of the one or more material handling vehicles, or a combination thereof.

In other aspects, the first visualization includes an indication of a measured environmental impact over a period of time for the one or more material handling vehicles, an indication of estimated environmental impact over a period of time for the one or more material handling vehicles, or a combination thereof.

In some aspects, the environmental impact corresponds to energy consumption, heat emission, or a combination thereof.

In further aspects, the instructions further cause the processor to generate a second visualization of vehicle performance associated with the one or more material handling vehicles, the second visualization including an indicated correlation between operating parameters associated with the selected performance mode and the environmental impact of the selected performance mode and output the second visualization to the user interface.

In some aspects, the second visualization of vehicle performance includes a comparison of operating parameters associated with a plurality of performance modes, each performance mode associated with a unique environmental impact level.

In other aspects, the instructions further cause the processor to generate and display, to the user interface, a plurality of selectable performance modes, each selectable performance mode associated with a corresponding environmental impact level and a corresponding set of operating parameters.

In some aspects, the instructions further cause the processor to determine a set of facility power sources available for charging the one or more material handling vehicles, determine an energy source environmental impact associated with each facility power source, and display an indication of the set of facility power sources and the energy source environmental impact associated with each facility power source on the user interface.

In other aspects, the instructions further cause the processor to receive an energy source selection from the user interface to charge the one or more material handling vehicles using a selected facility power source and output a charging command to a charging controller to draw charging power from the selected facility power source.

In some aspects, the instructions further cause the processor to determine a charging scheme for charging the one or more material handling vehicles, the charging scheme including at least one selected facility power source and a charging profile, the charging profile including a charging rate, a ramp-up routine, a ramp-down routine, a charging voltage, a full charge procedure, a time to full charge, or a combination thereof, and output a charging command to a charging station controller to charge the one or more material handling vehicles according to the charging scheme.

In further aspects, the instructions cause the processor to determine the charging scheme based on a charging environmental impact associated with the charging scheme, a time of day, a detected charge level of the one or more material handling vehicles, or a combination thereof.

Examples disclosed herein provide a computing system for a material handling environment. The computing system includes a memory storing instructions and a processor in communication with the memory and a telemetry system. The processor is configured to execute the instructions to cause the processor to determine a set of facility power sources available for charging the one or more material handling vehicles, determine a plurality of charging schemes for a vehicle battery charger based at least in part on the set of facility power sources, simulate an environmental impact of each of the plurality of charging schemes, and output a result of the simulation to a user interface. Each charging scheme includes a power draw ratio from at least one selected facility power source and charging profile. The charging profile includes a charging rate, a ramp-up routine, a ramp-down routine, a full charge procedure, a time to full charge, or a combination thereof.

In some aspects, the instructions further cause the processor to determine a recommended charging scheme based on the simulation and output a command to a charging controller of the vehicle battery charger to control charging of the one or more material handling vehicles in accordance with the recommended charging scheme.

In other aspects, the telemetry system is associated with the one or more material handling vehicles, the vehicle battery charger, a facility, or a combination thereof.

In further aspects, the set of facility power sources include at least two of a mains energy source, a fuel energy source, a power bank energy source, a coal energy source, a solar energy source, a wind energy source, or a hydroelectric energy source.

Examples disclosed herein provide a method for a material handling environment. The method includes receiving energy consumption data of one or more material handling vehicles, simulating environmental impacts of the one or more material handling vehicles based at least in part on a selected performance mode and the energy consumption data, determining a set of facility power sources available for charging the one or more material handling vehicles, determining a plurality of charging schemes based at least in part on the set of facility power sources, simulating environmental impacts of the plurality of charging schemes, and displaying one or more of a first result of the simulation of environmental impacts of the one or more material handling vehicles or a second result of the simulation of environmental impacts of the plurality of charging schemes to a user interface.

### BRIEF DESCRIPTION OF DRAWINGS

FIG. 1 illustrates a right-side elevational view of a material handling vehicle, according to disclosed examples;

FIG. 2 is a block diagram of a computing system for a material handling environment, according to disclosed examples;

FIG. 3 is a block diagram of a remote server that may be implemented in conjunction with the computing system of FIG. 2, according to disclosed examples;

FIG. 4 illustrates a system for modifying environmental impact in a material handling environment, according to disclosed examples;

FIG. 5 is a flowchart of an example process for modifying environmental impact in a material handling environment, according to disclosed examples;

FIG. 6 is a flowchart of an example process for modifying environmental impact in a material handling environment, according to disclosed examples; and

FIG. 7 is a flowchart of an example process for modifying environmental impact in a material handling environment, according to disclosed examples.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

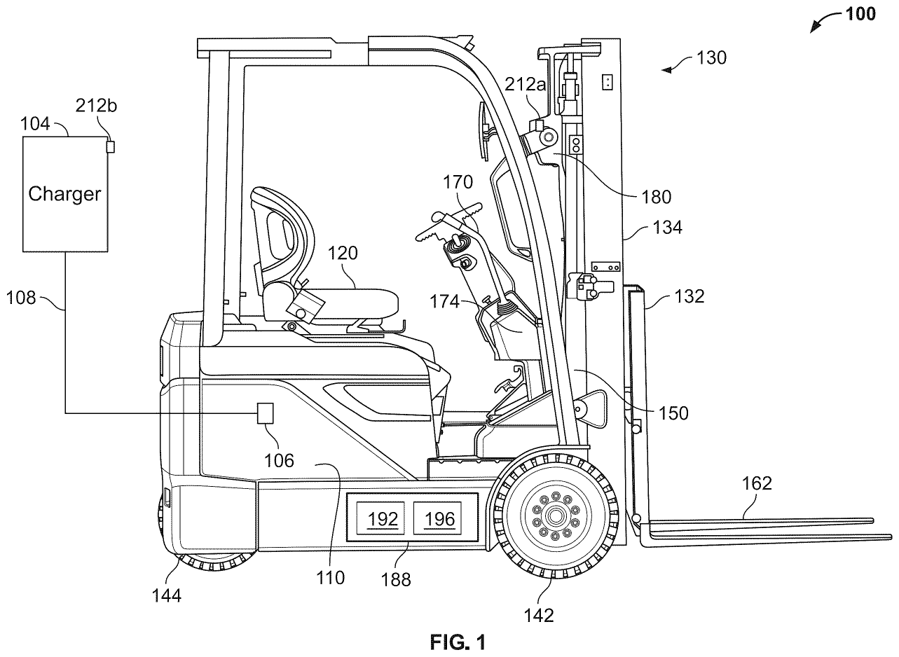

FIG. 1 illustrates a material handling vehicle 100 according to an embodiment. Specifically, the material handling vehicle 100 can be selectively coupled to one or more battery chargers 104 at a charging port 106 via a charging cable 108. In particular, the charging port 106 can be configured with one or more connection points to facilitate the electrical connection between a rechargeable battery pack and the one or more battery chargers 104. In some embodiments, a single battery charger 104 can be configured to connect with multiple connection points of the charging port 106 and provide either multiple sources of charging current or a single source of charging current that is split between the multiple connection points. In some embodiments, two battery chargers 104 can each be separately connected to two connection points of the charging port 106.

The material handling vehicle 100 can comprise a vehicle body 110 having a driver's seat 120 associated with the body 110. A mast 130 can be provided in front of the driver's seat 120. The body 110 can further be connected to sets of wheels 142 and 144 at a front portion and at a rear portion of the body 110, respectively. The front wheels 142 can be used for steering the material handling vehicle 100. Alternatively, the rear wheels 144 can be used for steering, or both sets of wheels 142 and 144 can be used for four-wheel steering.

The mast 130 can be supported on a front axle so that the mast 130 can be tiltable in a forward or a backward direction with respect to the body 110. The tilting of the mast 130 can be accomplished by using a tilt cylinder 150 that is in communication with the mast 130. The tilt cylinder 150 can retract or protract, thereby tiling the mast 130. In some forms, the mast 130 can be a two-level slide mast that can include an outer mast 132 and an inner mast 134. The outer mast 132 can be supported on the body 110 in a tiltable manner, and the inner mast 134 can be supported on the outer mast 132 in a liftable manner. The inner mast 134 can further include support forks 162. Moreover, the outer mast 132 can be provided with one or more lift cylinders to lift or lower the inner mast 134 with the forks 162.

A control lever 170 can be provided near the driver's seat 120 for controlling the material handling vehicle 100. For example, the control lever 170 can be used to shift the material handling vehicle 100 into forward or backward movements. The control lever 170 can be coupled to a main controller 174, which includes a processor, a memory, and a display 180 onboard the body 110. The display 180 can be provided near the driver's seat 120 facing inwardly toward the driver when the driver is seated in the driver's seat 120 or outward away from the driver. The display 180 can be configured to show various data or images gathered or collected by different sensors onboard the material handling vehicle 100. The display 180 can be provided in the form of an LCD display, an OLED display, or other suitable display devices.

Although a counter-balance type material handling vehicle 100 is depicted, it should be appreciated that the material handling vehicle 100 may be provided in the form of any material handling vehicle or other vehicle used to transport materials. For example, the material handling vehicle 100 may be provided in the form of a reach truck, a stacker, a pallet truck, or an order picker, for example.

The material handling vehicle 100 can be powered by a rechargeable battery pack 188. The battery pack 188 can include a housing and a plurality of battery modules 192. In some forms, the battery modules 192 are provided in the form of Lithium-Ion (Li-ion) batteries, Lithium Iron Phosphate (LiFePO4) batteries, Nickel-Metal Hydride (NiMH) batteries, Nickel-Cadmium (NiCd) batteries, Lead-Acid batteries, Sodium-Ion batteries, or other batteries known in the art. In some forms, in particular when the battery modules 192 are provided as Li-ion batteries, the battery pack 188 includes a battery management system (BMS) 196. The BMS 196 includes a processor, a memory, and one or more sensors configured to determine current draw and voltage values. The housing can include spacers, other structural plates, and other vibration dampening or cooling elements such as foam cushioning. In some embodiments, the battery pack 188 and/or the battery modules 192 themselves can include one or more sensors configured to sense one or more parameters of the battery pack 188 (e.g., charge status, temperature level, and the like) and/or the battery modules 192 and communicate the sensed parameters to the BMS 196 or the main controller 174 for aggregation, storage and or communicating the sensed parameters to other system components. For example, the battery pack 188 can include one or more of a temperature sensor, a voltage sensor, and/or a current sensor.

The BMS 196 is coupled electrically, communicatively, or both with each of the battery modules 192, the display 180, and the main controller 174. In systems with the BMS 196, the BMS 196 serves as the central gatekeeper for charging the battery pack 188 and delivering power from the battery pack 188 to the material handling vehicle 100. For example, the BMS 196 can be programmed to control battery charging by the charger 104. The BMS 196 can also be programmed to control the delivery of power to one or more of the display 180, the main controller 174, the traction motors, and other components of the material handling vehicle 100. In systems without the BMS 196, the main controller 174 serves as the central gatekeeper for charging the battery pack 188 and delivering power from the battery pack 188 to the material handling vehicle 100.

The material handling vehicle 100 can be selectively connected to a charger controller 198 of the charger 104 via the charging port 106 for the transfer of data, instructions, commands, information, and the like. The charger controller 198 can include a processor and a memory for storing battery charging instructions for execution by the processor. In some embodiments, communication lines included in the charging port 106 are provided in the form of CAN bus communication lines and can include a CAN high wire and a CAN low wire. Alternatively, or in addition, the communication lines included in the charging port 106 can be configured to provide other electronic communication methods known in the art. In some forms, the communication lines included in the charging port 106 also include a pilot line to identify when a proper connection between the battery pack 188 and the charger controller 198 is made. During charging, the charger 104 can supply electrical energy to the material handling vehicle 100, which stores the electrical energy in the battery pack 188.

As will be described in greater detail below, the material handling vehicle 100 may be equipped with a variety of vehicle performance modes. These vehicle performance modes can enable customizations for lifting, driving, tilting, swinging, braking, use of auxiliary attachments powered by hydraulic and/or electric sources, etc. The material handling vehicle performance modes can be programmed and customized locally or remotely by a fleet manager or by a computing device. Each performance mode may be associated with a defined or configurable set of operating parameters. The operating parameters associated with each performance mode can include, for example, maximum acceleration, maximum lift speed, steering sensitivity, braking force, regenerative braking parameters, mast lowering speed, and other vehicle operation characteristics.

Due to the variations in operating parameters, each performance mode is thus associated with varying levels of environmental impact. As an example, a first performance mode with low environmental impact (e.g., an energy saving performance mode) may limit acceleration and lift speed of the material handling vehicle 100 to reduce energy consumption. As another example, a second performance mode with relative higher environmental impact (e.g., a high performance mode) may allow for maximum acceleration and lift speed to prioritize productivity.

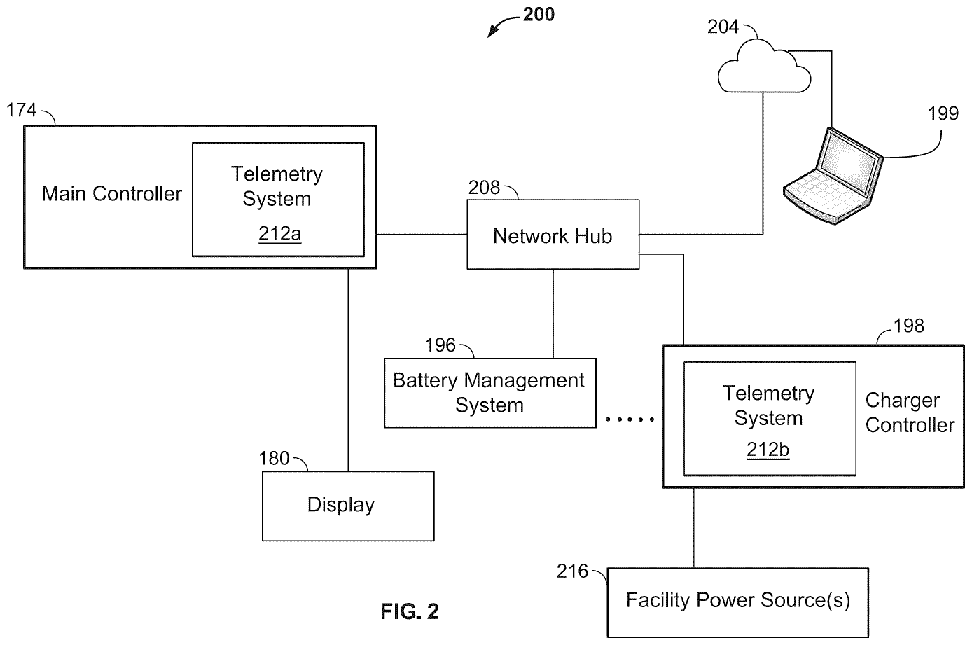

FIG. 2 is a block diagram of a computing system 200 to which the material handling vehicle 100 of FIG. 1 is connected, according to some examples. FIG. 2 illustrates that in some embodiments, one or both of the main controller 174, the BMS 196, and the charger controller 198 can be communicatively coupled to a remote server 204. A network hub 208 can be provided, which is communicatively coupled to the remote server 204, the main controller 174 via a telemetry system 212a installed on or associated with the material handling vehicle 100, the BMS 196, and a telemetry system 212b installed on or associated with the charger controller 198 via a telemetry system 212b associated with the charger 104.

It should be understood that the telemetry systems 212a and 212b are described separately for the sake of disclosing telematic functions associated with the material handling vehicle 100 or the charger 104, but the telemetry system 212a and 212b may be incorporated into a single telemetry system that is associated with or installed on only one or the other of the material handling vehicle 100 and the charger 104. For example, in some forms, the telemetry system 212a and the telemetry system 212b are provided as one or more telemetry devices installed on or associated with the material handling vehicle 100. In some forms, the telemetry system 212a and the telemetry system 212b are provided as one or more telemetry systems installed on or associated with the charger 104. Accordingly, any function herein that is described with respect to only one of the telemetry systems 212a, 212b, should be understood as applying to and being enabled in one or both of the telemetry systems 212a, 212b, either as separate or combined telemetry systems.

In the example shown in FIG. 2, the charging controller 198 can be connected to one or more facility power sources 216. For example, the one or more facility energy sources 216 can include a mains energy source, a fuel energy source (e.g., a gasoline, diesel, natural gas, or propane generator), a power bank energy source, a coal energy source, a solar energy source, a wind energy source, a hydroelectric energy source, or a combination thereof. The charging controller 198 may be configured to receive and monitor data related to the operational status, energy output, and availability of each facility power source 216. This monitored data may include power availability, energy cost, energy source type, and other environmental metrics. The charging controller 198 may be further designed to output the monitored data to the remote server 204 via the network hub 208. In some embodiments, the facility power sources 216 may communicate directly with the remote server 204, for example via the network hub 208. Accordingly, the network hub 208 can communicate the monitored data of each facility power source 216 to one or more of the main controller 174, the BMS 196, or the charger controller 198.

In some examples, the remote server 204 is designed to calculate a cost (e.g., an energy consumption cost and/or a monetary cost) associated with each selectable facility energy source 216. In some examples, the remote server 204 is designed to determine an overall fleet energy usage of one or more material handling vehicles 100. In some forms, the remote server 204 is designed to determine other operating parameters of the one or more facility energy sources 216. In some examples, each energy source of the facility energy sources 216 is associated with an environmental impact profile that is a measure or ranking of the environmental impact for that energy source when compared to the other selectable facility energy sources 216. The environmental impact profile can be stored by or otherwise accessible to the remote server 204.

The telemetry system 212a associated with the material handling vehicle and/or the telemetry system 212b associated with the charger 104 can include a plurality sensors designed to monitor performance of the material handling vehicle 100, a fleet of material handling vehicles 100, the charger 104, or a combination thereof. In that regard, temperature values and voltage values sensed by the battery pack 188 using one or both of the telemetry system 212a or the telemetry system 212b, as well as other truck performance information, can be communicated to the network hub 208 to be wirelessly transmitted via Wi-Fi, cellular connection, or GPS modems to the remote server 204 to be aggregated and/or processed. It is understood that the remote server 204 can alternatively or additionally be provided in the form of a local server or other cloud-connected server. In some examples, the remote server 204 is implemented in a distributed manner across various components of the computing system 200. In that regard, aspects of the remote server 204 can be implemented as part of the main controller 174, the BMS 196, the charging controller 198, or a combination thereof.

The network hub 208 can also receive data from the battery pack 188 associated with the charger 104. The network hub 208 can transmit any and all of the received data to the remote server 204 wirelessly. Further, the data can be processed at the remote server 204 or at a remote device to assess trends in battery voltage values, temperature values, state of charge (SOC) values, or state of health (SOH) values of the battery pack 188. Further, the raw or processed data can be accessed remotely via a remote device 199 having access to the remote server 204, for example, via the Internet. The remote device 199 may be any type of computing device, such as classical computing devices such as a desktop computer, laptop, mobile phone, smartphone, tablet, database, personal digital assistant (PDA), tablet, personal computer, a workstation, a mainframe computer, a supercomputer, a server, or another electronic device or quantum computer.

In some forms, over the air software updates, other programs, or data can be transmitted from the remote device 199 to the network hub 208 or from the remote server 204 itself to the network hub 208. In some forms, the communicative coupling between the BMS 196 and the network hub 208, and between the network hub 208 and the main controller 174, is established via Wi-Fi or short-range wireless communication protocols (e.g., controller area network (CAN) protocols, Bluetooth, ultra-wideband (UWB), Wi-Fi Direct, ZigBee, Z-Wave, a proprietary RF connection, etc.). It is understood that other forms of wired and wireless communication can also be provided.

In some forms, over the air software updates can be used to customize various functional aspects of the material handling vehicle 100 and the battery pack 188, and the charger 104. For example, the temperature, voltage, and current data from the sensors of the battery pack 188 can be aggregated and assessed to understand trends associated with the material handling vehicle 100 and the battery pack 188. In addition, the SOH of the battery pack 188 can be monitored, and the SOH data can be transmitted to the remote server 204 for aggregation and assessment. For example, the material handling vehicle 100 may be permitted to operate when the SOC value is below 20% in some applications, while in other applications, the material handling vehicle 100 may be prevented from operating at below 20% SOC. In some forms, the lifting and/or driving functions of the material handling vehicle 100 may be limited. In some examples, the charging functions of the charger 104 may be modified. For example, in cooler climates or cold storage applications, faster charging rates might be acceptable due to natural heat dissipation. In contrast, the battery charging rates may need to be reduced in warmer climates. In some forms, GPS data or publicly available weather data can be used for more specific customization. Further, certain models of material handling vehicles may require less battery power, and thus, the low SOC cutoff threshold for the operation of the material handling vehicle 100 may be set to a lower value.

Other software or firmware of the main controller 174, the BMS 196 of the battery pack 188, and/or the charger controller 198 can also be customized based on trends in battery SOH, different types/chemistries of batteries, different types or brands of battery chargers, different material handling vehicle models, or different climates and other weather conditions. For example, the main controller 174 can be programmed to limit the drive motor functions for the wheels 142, 144 and the hydraulic pump motor functions of the material handling vehicle 100 based on the temperature value of the battery pack 188 measured by the sensors of the battery pack 188.

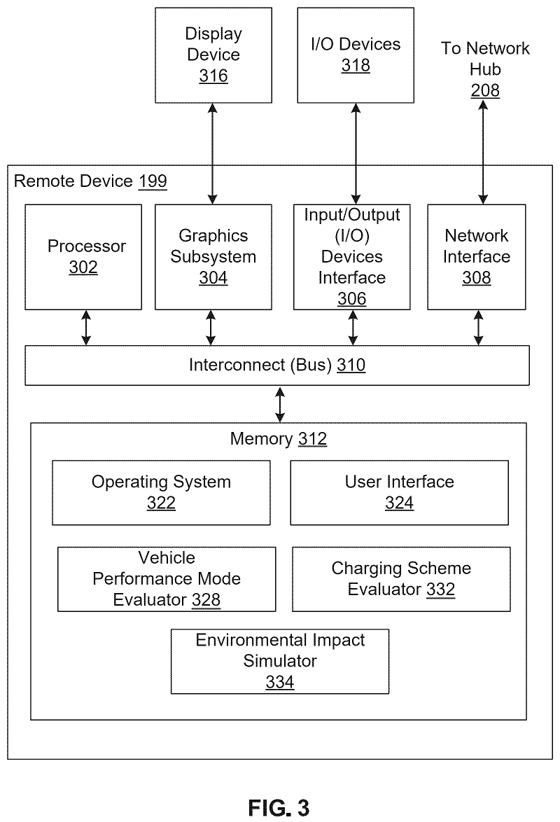

FIG. 3 is a block diagram of the remote server 204 that may be implemented in conjunction with the computing system 200 of FIG. 2. The remote server 204 can be implemented as one or more of a desktop computer, a laptop, a tablet, a smart phone, a server, or another suitable computing device.

As shown, the remote server 204 can include, without limitation, a processor 302, a graphics subsystem 304, an I/O devices interface 306, a network interface 308, an interconnect 310, and a memory 312. The interconnect 310 is adapted to facilitate transmission of data, such as programming instructions and application data, between the processor 302, the graphics subsystem 304, the I/O devices interface 306, the network interface 308, and the memory 312.

In some embodiments, the processor 302 (e.g., a CPU or similar processor) is adapted to retrieve and execute programming instructions stored in the memory 312. Similarly, the processor 302 is adapted to store and retrieve application data (e.g., software libraries) residing in the memory 312. The interconnect 310 is adapted to facilitate transmission of data, such as programming instructions and application data, between the processor 302, the graphics subsystem 304, the I/O devices interface 306, the network interface 308, and the memory 312.

In some embodiments, the graphics subsystem 304 is adapted to generate visualizations of vehicle performance data associated with one or more material handling vehicles 100, charging performance data associated with the charger 104, environmental impact data associated with one or more material handling vehicles 100, environmental impact data associated with the charger 104, or the like, and to provide the generated visualizations to a display device 316 such as the remote device 199. In some embodiments, the graphics subsystem 304 may be integrated into an integrated circuit, along with the processor 302.

The display device 316 may comprise any technically feasible means for generating an image for display. For example, the display device 316 may be fabricated using liquid crystal display (LCD) technology, cathode-ray technology, and light-emitting diode (LED) display technology. The display device 316 may include, for example, one or more monitors.

The input/output (I/O) device interface 306 is adapted to receive input data from user I/O devices 318 and transmit the input data to the processor 302 via the interconnect 310. For example, user I/O devices 318 may comprise one or more buttons, a keyboard, and a mouse or other pointing device. The I/O device interface 306 also includes an audio output unit adapted to generate an electrical audio output signal. User I/O devices 318 may comprise one or more speakers adapted to generate an acoustic output in response to the electrical audio output signal. In alternative embodiments, the display device 316 may include the speaker. In some examples, one or more material handling vehicles 100 or one or more chargers 104 can be connected to the I/O devices interface 306.

The memory 312 can be adapted to store both volatile and non-volatile data. The memory 312 can include programming instructions and application data that comprise an operating system 322, a user interface 324, vehicle performance mode evaluator 328, a charging scheme evaluator 332, and an environmental impact simulator 334. The operating system 322 performs system management functions such as managing hardware devices including the graphics subsystem 304, the I/O device interface 306, and the network interface 308. The operating system 322 also provides process and memory management models for the user interface 324, the vehicle performance evaluator 328, the charging scheme evaluator 332, and the environmental impact simulator 334. The user interface 324, such as a window and object metaphor, provides a mechanism for user interaction with the remote server 204. Persons skilled in the art recognize the various operating systems and user interfaces that are well-known in the art and suitable for incorporation into the remote server 204.

The vehicle performance mode evaluator 328 can be adapted to receive and evaluate vehicle performance data from one or more material handling vehicles such as the material handling vehicle 100. The performance data can include stored performance data (e.g., predetermined energy consumption or other performance data for certain vehicle types), sensed performance data received via the telemetry systems 212a, 212b, or both. In some examples, the energy consumption of certain vehicle types under certain conditions are tested and compiled in a predetermined look up table stored in the memory 312 or otherwise accessible by the remote server 204. The vehicle performance data can include energy consumption data, operating parameters, battery capacity and charge remaining data, vehicle task data, historical usage data, duty cycle profiles, operator identification, maintenance status, error codes, environmental conditions during operation (such as ambient temperature or humidity), and/or other telematics or sensor-derived metrics that may affect or reflect vehicle performance. Vehicle operating parameters can include, for example, acceleration limits, lift speed settings, steering sensitivity, braking force, regenerative braking intensity, mast lowering speed, auxiliary attachment usage profiles, maximum allowable load, throttle response, and other adjustable or monitored parameters that define the operational characteristics of the vehicle 100 in a given mode.

The vehicle performance mode evaluator 328 can be designed to evaluate the received vehicle performance data and generate, determine, or retrieve one or more selectable vehicle performance modes for the material handling vehicle or vehicles 100 based at least in part on the performance data. As an example, selectable vehicle performance modes can include, for example, an “Eco” mode with reduced acceleration and lift speed for increased energy efficiency, a “Standard” mode with balanced parameters for typical usage, and a “High-Performance” mode with increased acceleration, lift speed, and responsiveness for demanding tasks. However, other performance modes are also contemplated.

Each mode can be associated with a corresponding set of operating parameters, and each set of parameters can be selected by the remote server 204 to achieve a particular balance between productivity and environmental impact. The energy consumption and other operating parameters associated with each mode may be determined based on prior field testing, simulation, or real-time data aggregation. The remote server 204 may select or recommend a performance mode for one or more vehicles based at least in part on one or more of fleet-wide energy reduction goals, task requirements, operator input, the vehicle performance data, or the vehicle operating parameters. In some embodiments, the remote server 204 may dynamically modify the operating parameters within a selected performance mode, switch performance modes entirely, or recommend another performance mode to optimize environmental impact, operational efficiency, or both.

In some examples, the vehicle performance mode evaluator 328 invokes an environmental impact simulator 334 to simulate the environmental impact of each selectable performance mode. The environmental impact simulation may use energy consumption data from a predetermined look up table, real-time telemetry data, or a combination thereof, to estimate or calculate the resulting environmental impact of each performance mode. The simulation may consider factors such as direct or indirect energy usage, heat emission, greenhouse gas output, and/or other environmental metrics.

In some examples, each performance mode is dynamically generated or selected in accordance with an environmental impact reduction plan. In some examples, the environmental impact reduction plan defines a target percentage for emissions reduction or a maximum amount of emissions reduced per period of time (e.g., per month, per year, per decade, etc.), a target percentage of energy consumption reduction or a maximum amount of energy consumption per period of time, or a combination thereof.

In some examples, the environmental impact simulator 334 references the environmental impact reduction plan designed to target reductions in energy consumption, emissions, or other environmental metrics over a defined period. In that regard, the vehicle performance mode evaluator 328 may recommend or enforce performance modes consistent with achieving those targets. The environmental impact simulation may be used to estimate past, current, or future environmental impacts. In instances where real-time or historical vehicle operating data is unavailable, the simulator 334 may rely on estimated or modeled data to assess environmental impact.

In some examples, the vehicle performance mode evaluator 328 outputs (e.g., to the display device 316) a visualization of the environmental impact associated with some or all of the simulated vehicle performance modes. In some examples, the visualization of environmental impact includes an indication of direct or indirect energy consumption, heat emission, greenhouse gas emission, or a combination thereof associated with vehicle performance modes. In some examples, the visualization includes a comparison of operating parameters associated with different performance modes. In some examples, each performance mode is associated with a different environmental impact level.

In some examples, the vehicle performance mode evaluator 328 determines a recommended performance mode for one or more material handling vehicles 100 based at least in part on the results of the simulation. The vehicle performance mode evaluator 328 can provide an indication of the recommended performance mode to the display device 316. In some examples, the vehicle performance mode evaluator 328 automatically outputs a command to the one or more material handling vehicles 100 (e.g., via the network hub 208) to operate according to the recommended performance mode. In other examples, the vehicle performance mode evaluator 328 outputs the command responsive to receiving a user selection or confirmation of a vehicle performance mode (e.g., via the I/O devices interface 306 or the network hub 208).

In some examples, the vehicle performance mode evaluator 328 outputs (e.g., to the display device 316) a visualization of vehicle performance associated with the one or more material handling vehicles 100. The visualization of vehicle performance can include an indication of a correlation between operating parameters associated with a selected performance mode and an environmental impact of the selected performance mode. For example, the visualization can indicate a contribution of each operating parameter to the simulated environmental impact.

In some embodiments, the performance mode evaluator 328 can dynamically alter one or more operating parameters associated with a particular performance mode based on real-time data or an environmental impact reduction plan. In other embodiments, each performance mode is associated with a predetermined set of operating parameters, and the remote server is configured to switch the active performance mode of the vehicle by outputting a command to the material handling vehicle.

The charging scheme evaluator 332 can be adapted to evaluate power source and/or charging data from the charger 104, the facility power sources 216, or both. In some examples, the charging scheme evaluator 332 is further adapted to evaluate vehicle performance data from the one or more material handling vehicles 100. Data evaluated by the charging scheme evaluator 332 can include stored data (e.g., predetermined energy consumption or other performance data for certain vehicle types, charger types, or facility power source types), sensed data received via the telemetry systems 212a, 212b or both. The power source and/or charging data can include energy efficiency data associated with the facility power sources 216, SOC information associated with one or more material handling vehicles 100 (e.g., material handling vehicles connected to a charger 104), charging parameters (e.g., a charging rate, a ramp-up/ramp-down routines, a charging voltage, a full charge behavior, a time to full charge, etc.) related to the charging of the one or more material handling vehicles 100.

The power source and/or charging data can further include information related to the availability of energy from the one or more facility power sources 216, a monetary cost of different facility power sources 216 (e.g., the presence or absence of surge pricing for mains power), an amount of stored power in one or more power banks, weather conditions related to a solar, hydroelectric, or wind power source, peak energy demand times, low-carbon hours, or the like. For example, during peak energy demand times, utilities often must rely on power from less energy efficient or more environmental impactful power plants (e.g., coal energy sources). Accordingly, the charging scheme evaluator 332 may elect to reduce charging rates or select a charging scheme with reduced charging rates to reduce the environmental impact and ultimately reduce costs during peak energy demand hours. Conversely, the charging scheme evaluator 332 may elect to increase charging rates or select a charging scheme with increased charging rates if battery charging is requested during low-carbon hours when renewable energy sources are more available (solar, wind, or hydroelectric energy sources). The times of peak energy demand hours and low-carbon hours can be dynamically polled or received from energy companies to ensure that the most accurate data about energy source availability and timing is assessed by the charging scheme evaluator 332. In some forms, the energy scheme can be automatically updated based on changes to the peak energy demand hours and low-carbon hours as periodically polled or received from energy companies.

The charging scheme evaluator 332 can be designed to evaluate received data and to determine one or more selectable charging schemes for charging one or more material handling vehicles 100. Each charging scheme can include a selection of one or more facility power sources 216 from which charging power is to be drawn and a charging profile that includes parameters of the charging process. The selection of one or more facility power sources 216 can further include a power draw ratio for each selected facility power source 216. For example, the selection of one or more facility power sources 216 can include a 30% power draw from a mains power source and a 70% power draw from a power bank power source. As another example, the selection of one or more facility power sources 216 can include a 55% power draw from a power bank power source, a 30% power draw from a solar power source, and a 15% power draw from a mains power source.

The power draw ratio may also be time-dependent, such that certain charging schemes include different ratios of power draw during peak energy demand hours or low-carbon hours to reduce energy costs and/or the environmental impact of battery charging. In some forms, the charging scheme may restrict some or all battery charging if certain types of energy sources or amounts of energy from certain energy sources are available or if charging is attempted during peak demand hours.

Parameters included in the charging profile can include, for example, a charging rate, a ramp-up routine, a ramp-down routine, a charging voltage, a full charge procedure, a time to full charge, or a combination thereof. The charging rate can refer to the amount of current or power delivered to the battery pack 188 per unit of time, which may be expressed in amperes or kilowatts. A ramp-up routine can specify how the charging current or power is gradually increased to the target charging rate to minimize stress on the battery modules 192 and electrical system of the material handling vehicle 100. A ramp-down routine can specify how the charging current or power is reduced as the battery approaches full charge, which can extend battery life and improve safety. The charging voltage parameter can set the target voltage level for the charging process, which may vary depending on battery chemistry and state of charge. The full charge procedure can outline the steps taken when the battery reaches full charge, such as transitioning to a trickle charge, balancing cells/modules, or disconnecting the charger 104. The time to full charge can represent the estimated or measured duration required to fully charge the battery pack 188 under the selected charging profile. Each of these parameters can be individually or collectively adjusted to optimize charging efficiency, battery longevity, and environmental impact.

In some examples, the charging scheme evaluator 332 invokes the environmental impact simulator 334 to simulate the environmental impact of each selectable charging scheme. The environmental impact simulation may consider energy source selection (e.g., renewable vs. non-renewable sources), the proportion of energy drawn from each source, the efficiency of the charging process, and the associated emissions or environmental effects of each energy source and charging profile. The simulation may use energy consumption data from predetermined look up tables, real-time telemetry data from chargers 104 and facility power sources 216, or a combination thereof. The simulation may generate estimated, measured, or modeled environmental impact data for past, present, or future charging sessions.

The environmental impact simulator 334 may perform charging scheme simulations with respect to the environmental impact plan. The environmental impact reduction plan may specify goals such as reducing greenhouse gas emissions, increasing the proportion of renewable energy used for charging, or minimizing peak energy demand. The charging scheme evaluator 332 may select or recommend charging schemes that align with the environmental impact reduction plan or may dynamically adjust charging parameters and energy source selection to achieve ongoing compliance with environmental targets.

In some examples, the charging scheme evaluator 332 outputs (e.g., to the display device 316) a visualization of the environmental impact associated with some or all of the simulated charging schemes. In some examples, the visualization of environmental impact includes an indication of direct and/or indirect energy consumption, heat emission, greenhouse gas emission, renewable energy usage, or a combination thereof associated with the charging schemes. In some examples, the visualization includes a comparison of charging profile parameters associated with the charging schemes. In some examples, each charging scheme is associated with a different environmental impact level.

In some examples, the charging scheme evaluator 332 generates, determines, or receives a recommended charging scheme for charging one or more material handling vehicles 100 based at least in part on the results of the environmental impact simulation. The charging scheme evaluator 332 can provide an indication of the recommended charging scheme to the display device 316. In some examples, the charging scheme evaluator 332 automatically outputs a command to one or more chargers 104 (e.g., via the network hub 208) to operate according to the recommended charging scheme. In other examples, the charging scheme evaluator 332 outputs the command responsive to receiving a user selection or confirmation of a charging scheme (e.g., via the I/O devices interface 306 or the network hub 208).

In some embodiments, the remote server 204 may use one or more artificial intelligence models to recognize trends, provide recommendations to reduce environmental impact, and generate customized reports of individual or collective impacts of a user's decisions.

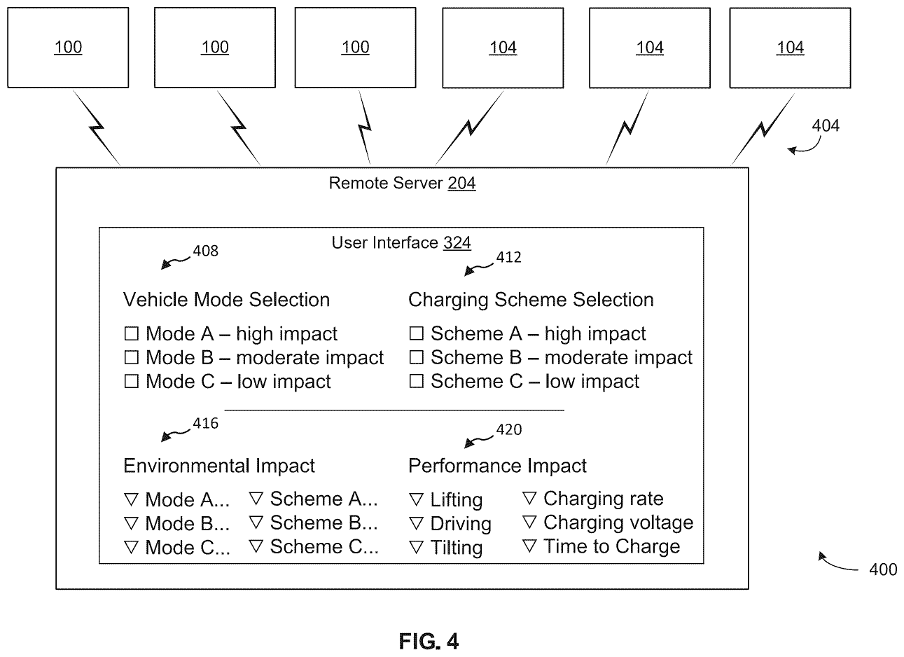

FIG. 4 illustrates a system 400 for modifying environmental impact in a material handling environment, according to some examples. Aspects of the system 400 may be similar to aspects of the system 200 described above with respect to FIG. 2. For example, the system 400 can include one or more material handling vehicles 100, one or more chargers 104, and a remote server 204 communicatively connected to the one or more material handling vehicles and the one or more chargers 104. In some instances, the one or more material handling vehicles 100 may comprise a fleet of material handling vehicles. In the example of FIG. 4, the remote server 204 may communicate with at least one of the one or more material handling vehicles 100 and/or the one or more chargers 104 via network communication links 404.

The remote server 204 may provide, with the user interface 324, a vehicle mode selection 408 to allow a fleet manager to select one or more vehicle performance modes for the one or more material handling vehicles 100. The vehicle performance modes included in the vehicle performance mode selection 408 can be substantially similar to the vehicle performance modes described above with respect to FIG. 3. In the example of FIG. 4, a first performance mode (e.g., Mode A) can be associated with a highest relative environmental impact of the plurality of performance modes (e.g., a high energy consumption), a second performance mode (e.g., Mode B) can be associated with a moderate relative environmental impact of the plurality of performance modes, and a third performance mode (e.g., Mode C) can be associated with a relative lowest environmental impact of the plurality of performance modes. In some examples, the vehicle mode selection 408 further includes an indication of operating parameters associated with each mode, such as acceleration parameters, lift speed parameters, braking force parameters, and regenerative braking parameters, mast lowering parameters, time to max speed parameters, or a combination thereof, which can contribute to the energy consumption associated with that mode.

The remote server 204 may provide, with the user interface 324, a charging scheme selection 412 to allow a fleet manager to select one or more charging schemes for charging the one or more material handling vehicles 100 with the chargers 104. The charging schemes included in the charging schemes selection 412 can be substantially similar to the charging schemes described above with respect to FIG. 3. In the example of FIG. 4, a first charging scheme (e.g., Scheme A) can be associated with a highest relative environmental impact of the plurality of charging schemes (e.g., a high energy consumption), a second charging scheme (e.g., Scheme B) can be associated with a moderate relative environmental impact of the plurality of charging schemes, and a third charging scheme (e.g., Scheme C) can be associated with a relative lowest environmental impact of the plurality of charging schemes. In some examples, the charging schemes selection 412 further includes an indication of one or more selected facility power sources and charging profile parameters associated with each charging scheme.

The remote server 204 may provide, with the user interface 324, a visual representation of an environmental impact 416 associated with each performance mode and charging scheme. The visual representation of environmental impact 416 can include an estimation of environmental outputs from at least one of the one or more material handling vehicles 100 in real-time based on the selected performance mode of the one or more material handling vehicles 100 and/or an estimation of environmental outputs from the charger 104 in real-time based on the selected charging scheme. For example, responsive to a detected selection of a low energy consumption mode for the one or more material handling vehicles 100 or a low energy charging scheme, the remote server 204 can generate a visualization of the estimated positive impact to the environmental outputs. In some examples, the remote server 204 calculates environmental impact per energy consumption mode from work cycle testing (e.g., run-times and performance characteristics). In some examples, the remote server 204 may sum environmental impacts per vehicle 100 or an entire fleet, or per charger 104 or an entire charging bay.

The remote server 204 may provide, with the user interface 324, a visual representation of a performance impact 420. The visual representation of a performance impact 420 can provide performance data and operating parameters for each vehicle function (e.g., lifting, driving, tilting, swinging, and/or mast lowering) or charging scheme (e.g., facility energy source, charging rate, ramp-up routine, ramp-down routine, charging voltage, full charge procedure, time to full charge). In some embodiments, different vehicle functions and charging schemes may save more energy than others. In some examples, an amount of energy saving associated with vehicle operating parameters or charging parameters is included in the visual representation of a performance impact 420. In some examples, the visual representation of environmental impact 416 and/or the visual representation of performance impact 420 includes charts, graphs, or recommendations.

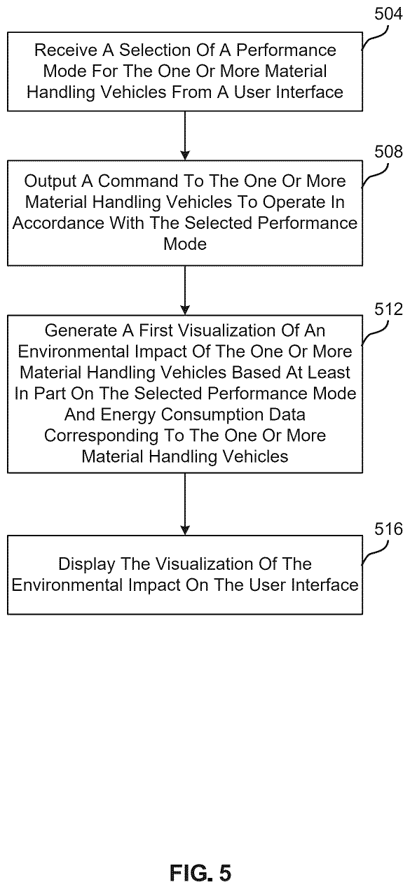

FIG. 5 is a flowchart of an example method 500 for modifying environmental impact in a material handling environment, according to disclosed examples. Operations included in the method 500 may be performed by a computing device associated with a material handling environment, such as the remote server 204 of FIGS. 2-4. The remote server 204 may perform operations of the method 500 in conjunction with other components described herein, such as the one or more material handling vehicles 100, the one or more chargers 104, the telemetry systems 212a, 212b or combinations thereof.

At step 504, the method 500 can include receiving a selection of a performance mode for the one or more material handling vehicles from a user interface. The performance mode can be associated with a set of operating parameters including acceleration parameters, lift speed parameters, steering parameters, braking force parameters, regenerative braking parameters, mast lowering parameters, or a combination thereof. In some examples, the method 500 includes dynamically selecting the performance mode based on a time of day, a task performed by the one or more material handling vehicles, a remaining charge of the one or more material handling vehicles, or a combination thereof.

At step 508, the method 500 can include outputting a command to the one or more material handling vehicles to operate in accordance with the selected performance mode.

At step 512, the method 500 can include generating a first visualization of an environmental impact of the one or more material handling vehicles based at least in part on the selected performance mode and energy consumption data corresponding to the one or more material handling vehicles. In some examples, the first visualization includes an indication of a measured environmental impact over a period of time for the one or more material handling vehicles, an indication of estimated environmental impact over a period of time for the one or more material handling vehicles, or a combination thereof. The environmental impact can include an indication of energy consumption, heat emission, or a combination thereof.

At step 516, the method 500 can include displaying the visualization of the environmental impact on a user interface.

In some examples, the method 500 includes receiving an environmental impact reduction plan and selecting operating parameters associated with the performance mode according to the environmental impact reduction plan. The environmental impact reduction plan can indicate a target energy consumption reduction per period of time for the one or more material handling vehicles.

In some examples, the method 500 includes modifying the performance mode selection based on the energy consumption data and outputting a command to the one or more material handling vehicles indicative of the modification.

In some examples, the method 500 includes generating a second visualization of vehicle performance associated with the one or more material handling vehicles and outputting the second visualization to the user interface. The second visualization can include an indicated correlation between operating parameters associated with the selected performance mode and environmental impact of the selected performance mode. The second visualization of vehicle performance includes a comparison of operating parameters associated with a plurality of performance modes, each performance mode associated with a different environmental impact level. In some forms, the user interface is configured to display the first visualization and the second visualization simultaneously to allows the user to compare performance modes.

In some examples, the method 500 includes generating and displaying, to the user interface, a plurality of selectable performance modes. Each selectable performance mode can be associated with a corresponding environmental impact level and a corresponding set of operating parameters.

In some examples, the method 500 includes determining a set of facility power sources available for charging the one or more material handling vehicles, determining an energy source environmental impact associated with each facility power source, and displaying an indication of the set of facility power sources and the energy source environmental impact associated with each facility power source on the user interface. In such examples, the method 500 can include receiving an energy source selection from the user interface to charge the one or more material handling vehicles using a selected facility power source and outputting a charging command to a charging controller to draw charging power from the selected facility power source.

In such examples, the method 500 can include determining a charging scheme for charging the one or more material handling vehicles and outputting a charging command to a charging controller (e.g., a charging station controller included in or connected to the one or more chargers 104) to charge the one or more material handling vehicles according to the charging scheme. The charging scheme can include at least one selected facility power source and a charging profile, the charging profile including a charging rate, a ramp-up routine, a ramp-down routine, a charging voltage, a full charge procedure, a time to full charge, or a combination thereof. In some examples, the method 500 includes determining the charging scheme based on a charging environmental impact associated with the charging scheme, a time of day, a detected charge level of the one or more material handling vehicles, or a combination thereof.

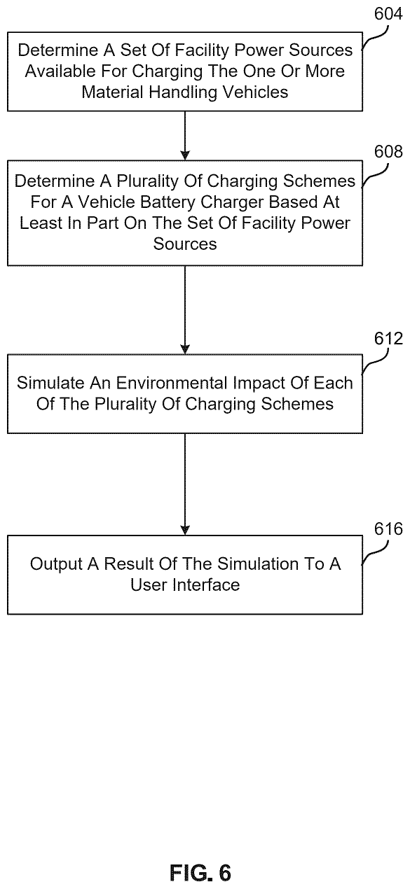

FIG. 6 is a flowchart of an example method 600 for modifying environmental impact in a material handling environment, according to disclosed examples. Operations included in the method 600 may be performed by a computing device associated with a material handling environment, such as the remote server 204 of FIGS. 2-4. The remote server 204 may perform operations of the method 600 in conjunction with other components described herein, such as the one or more material handling vehicles 100, the one or more chargers 104, the telemetry systems 212a, 212b or combinations thereof.

At step 604, the method 600 can include determining a set of facility power sources available for charging the one or more material handling vehicles. The set of facility power sources can include at least two of a mains energy source, a fuel energy source, a power bank energy source, a coal energy source, a solar energy source, a wind energy source, or a hydroelectric energy source.

At step 608, the method 600 can include determining a plurality of charging schemes for a vehicle battery charger based at least in part on the set of facility power sources. Each charging scheme can include a power draw ratio from at least one selected facility power source and charging profile, the charging profile including a charging rate, a ramp-up routine, a ramp-down routine, a full charge procedure, a time to full charge, or a combination thereof. In some examples, the method 600 includes determining a recommended charging scheme based on the simulation and outputting a command to a charging controller of the vehicle battery charger to control charging of the one or more material handling vehicles in accordance with the recommended charging scheme.

At step 612, the method 600 can include simulating an environmental impact of each of the plurality of charging schemes.

At step 616, the method 600 can include outputting a result of the simulation to a user interface.

In some examples, the method 600 includes receiving an environmental impact reduction plan and selecting facility power sources and charging profiles associated with the charging scheme according to the environmental impact reduction plan. The environmental impact reduction plan can indicate a target energy consumption reduction or target facility power source type per period of time for the charger.

In some examples, the method 600 includes modifying the charging scheme based on the availability of energy from one or more facility power sources, a monetary cost of different facility power sources (e.g., the presence or absence of surge pricing for mains power), an amount of stored power in one or more power banks, weather conditions related to a solar, hydroelectric, or wind power source, or the like and outputting a command to the charger indicative of the modification.

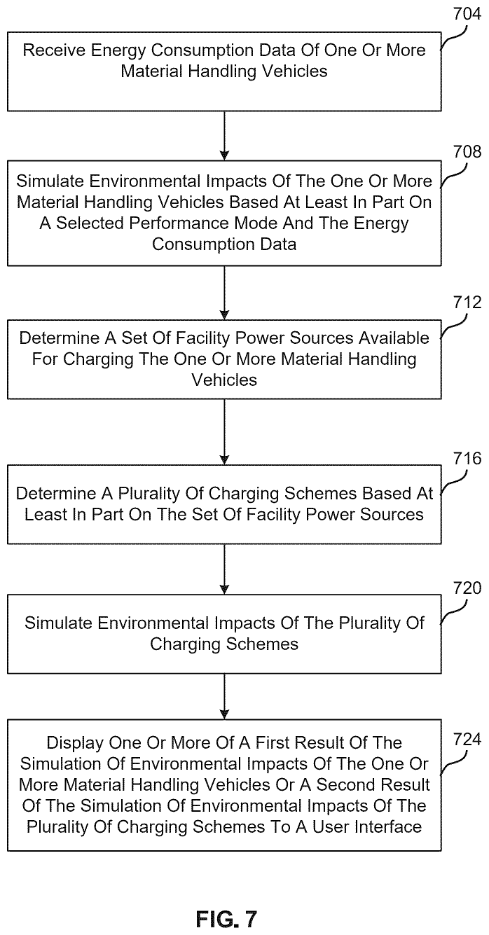

FIG. 7 is a flowchart of an example method 700 for modifying environmental impact in a material handling environment, according to disclosed examples. Operations included in the method 700 may be performed by a computing device associated with a material handling environment, such as the remote server 204 of FIGS. 2-4. The remote server 204 may perform operations of the method 700 in conjunction with other components described herein, such as the one or more material handling vehicles 100, the one or more chargers 104, the telemetry systems 212a, 212b or combinations thereof.

At step 704, the method 700 can include receiving energy consumption data of one or more material handling vehicles. The energy consumption data can be received from a telemetry system, can be stored in and retrieved from memory, can be received as user input, or combinations thereof.

At step 708, the method 700 can include simulating environmental impacts of the one or more material handling vehicles based at least in part on a selected performance mode and the energy consumption data.

At step 712, the method 700 can include determining a set of facility power sources available for charging the one or more material handling vehicles.

At step 716, the method 700 can include determining a plurality of charging schemes based at least in part on the set of facility power sources.

At step 720, the method 700 can include simulating environmental impacts of the plurality of charging schemes.

At step 724, the method 700 can include displaying one or more of a first result of the simulation of environmental impacts of the one or more material handling vehicles or a second result of the simulation of environmental impacts of the plurality of charging schemes to a user interface.

The processors described herein may be any suitable processing device or set of processing devices such as, but not limited to a microprocessor, a microcontroller-based platform, a suitable integrated circuit, one or more field programmable gate arrays (FPGAs), or one or more application-specific integrated circuits (ASICs). The memories described herein may be volatile memory (e.g., RAM, which may include magnetic RAM, ferroelectric RAM, and any other suitable forms), non-volatile memory (e.g., disk memory, FLASH memory, EPROMs, EEPROMs, non-volatile solid-state memory, etc.), unalterable memory (e.g., EPROMs), read-only memory, or high-capacity storage devices (e.g., hard drives, solid state drives, etc.). In some examples, the memory includes multiple types of memory, particularly both volatile memory and non-volatile memory.

The memories are provided in the form of non-transitory computer-readable media on which one or more sets of instructions, such as the software for operating the methods of the present disclosure, can be embedded. The embedded instructions may embody one or more of the methods or logic as described herein. The embedded instructions may reside completely, or at least partially, within the memories and/or the processors during execution of the instructions. The term “non-transitory computer-readable medium” should be understood to include a single medium or multiple media, such as a centralized or distributed database or associated caches and servers that store one or more sets of instructions. The term “non-transitory computer-readable medium” also includes any tangible medium that is capable of storing, encoding, or carrying a set of instructions for execution by a processor or that causes a system to perform any one or more of the methods or operations disclosed herein. As used herein, the term “non-transitory computer-readable medium” includes any type of computer-readable storage device and/or storage disk and excludes propagating signals.

In some forms, the processors may include multiple processors and the memories may include multiple memories. One or more of the multiple processors may be coupled with one or more of the multiple memories, which may, individually or collectively, be configured to perform various functions described herein. Further, as described herein, being “configured to,” being “configurable to,” and being “operable to” may be used interchangeably and may be associated with a capability, when executing code (e.g., processor-executable code) stored in the memory or otherwise, to perform one or more of the functions described herein.

Although the invention has been described in language specific to structural features and/or methodological acts, it is to be understood that the invention is not necessarily limited to the specific features or acts described. Rather, the specific features and acts are disclosed as exemplary forms of implementing the invention.

What is claimed is:

1. A computing system for a material handling environment, comprising:
a memory storing instructions; and
a processor in communication with the memory and a telemetry system of one or more material handling vehicles, the processor configured to execute the instructions to cause the processor to:
receive a selection of a performance mode for the one or more material handling vehicles from a user interface;
output a command to the one or more material handling vehicles to operate in accordance with the selected performance mode;
generate a first visualization of an environmental impact of the one or more material handling vehicles based at least in part on the selected performance mode and energy consumption data corresponding to the one or more material handling vehicles; and
display the visualization of the environmental impact on the user interface.

2. The computing system of claim 1, wherein the performance mode is associated with a set of operating parameters including acceleration parameters, lift speed parameters, steering parameters, braking force parameters, regenerative braking parameters, mast lowering parameters, or a combination thereof.

3. The computing system of claim 1, wherein the instructions further cause the processor to:
receive an environmental impact reduction plan; and
select operating parameters associated with the performance mode according to the environmental impact reduction plan.

4. The computing system of claim 3, wherein the environmental impact reduction plan indicates a target energy consumption reduction per period of time for the one or more material handling vehicles.

5. The computing system of claim 1, wherein the instructions further cause the processor to:
modify the performance mode selection based on the energy consumption data; and
output a command to the one or more material handling vehicles to implement the modification.

6. The computing system of claim 1, wherein the instructions further cause the processor to:
dynamically select the performance mode based on a time of day, a task performed by the one or more material handling vehicles, a remaining battery charge of the one or more material handling vehicles, or a combination thereof.

7. The computing system of claim 1, wherein the first visualization includes an indication of a measured environmental impact over a period of time for the one or more material handling vehicles, an indication of estimated environmental impact over a period of time for the one or more material handling vehicles, or a combination thereof.

8. The computing system of claim 1, wherein the environmental impact corresponds to energy consumption, heat emission, or a combination thereof.

9. The computing system of claim 1, wherein the instructions further cause the processor to:
generate a second visualization of vehicle performance associated with the one or more material handling vehicles, the second visualization including an indicated correlation between operating parameters associated with the selected performance mode and the environmental impact of the selected performance mode; and
output the second visualization to the user interface.

10. The computing system of claim 9, wherein the second visualization of vehicle performance includes a comparison of operating parameters associated with a plurality of performance modes, each performance mode associated with a unique environmental impact level.

11. The computing system of claim 1, wherein the instructions further cause the processor to:
generate and display, to the user interface, a plurality of selectable performance modes, each selectable performance mode associated with a corresponding environmental impact level and a corresponding set of operating parameters.

12. The computing system of claim 1, wherein the instructions further cause the processor to:
determine a set of facility power sources available for charging the one or more material handling vehicles;
determine an energy source environmental impact associated with each facility power source; and
display an indication of the set of facility power sources and the energy source environmental impact associated with each facility power source on the user interface.

13. The computing system of claim 12, wherein the instructions further cause the processor to:
receive an energy source selection from the user interface to charge the one or more material handling vehicles using a selected facility power source; and
output a charging command to a charging controller to draw charging power from the selected facility power source.

14. The computing system of claim 12, wherein the instructions further cause the processor to:
determine a charging scheme for charging the one or more material handling vehicles, the charging scheme including at least one selected facility power source and a charging profile, the charging profile including a charging rate, a ramp-up routine, a ramp-down routine, a charging voltage, a full charge procedure, a time to full charge, or a combination thereof; and
output a charging command to a charging station controller to charge the one or more material handling vehicles according to the charging scheme.

15. The computing system of claim 14, wherein the instructions cause the processor to determine the charging scheme based on a charging environmental impact associated with the charging scheme, a time of day, a detected charge level of the one or more material handling vehicles, or a combination thereof.

16. A computing system for a material handling environment, the computing system comprising:
a memory storing instructions; and
a processor in communication with the memory and a telemetry system, the processor configured to execute the instructions to cause the processor to:
determine a set of facility power sources available for charging one or more material handling vehicles;
determine a plurality of charging schemes for a vehicle battery charger based at least in part on the set of facility power sources, each charging scheme including a power draw ratio from at least one selected facility power source and charging profile, the charging profile including a charging rate, a ramp-up routine, a ramp-down routine, a full charge procedure, a time to full charge, or a combination thereof;
simulate an environmental impact of each of the plurality of charging schemes; and
output a result of the simulation to a user interface.

17. The computing system of claim 16, wherein the instructions further cause the processor to:
determine a recommended charging scheme based on the simulation; and
output a command to a charging controller of the vehicle battery charger to control charging of the one or more material handling vehicles in accordance with the recommended charging scheme.

18. The computing system of claim 17, wherein the telemetry system is associated with the one or more material handling vehicles, the vehicle battery charger, a facility, or a combination thereof.

19. The computing system of claim 16, wherein the set of facility power sources include at least two of a mains energy source, a fuel energy source, a power bank energy source, a coal energy source, a solar energy source, a wind energy source, or a hydroelectric energy source.

20. A method for a material handling environment, the method comprising:
receiving energy consumption data of one or more material handling vehicles;
simulating environmental impacts of the one or more material handling vehicles based at least in part on a selected performance mode and the energy consumption data;
determining a set of facility power sources available for charging the one or more material handling vehicles;
determining a plurality of charging schemes based at least in part on the set of facility power sources;
simulating environmental impacts of the plurality of charging schemes; and
displaying one or more of a first result of the simulation of environmental impacts of the one or more material handling vehicles or a second result of the simulation of environmental impacts of the plurality of charging schemes to a user interface.
